(19) United States
(12) Patent Application Publication
(10) Pub. No.: US 2021/0108603 A1
(43) Pub. Date: Apr. 15, 2021

(54) FUEL INJECTION VALVE

(71) Applicant: DENSO CORPORATION, Kariya-city (JP)

(72) Inventors: Niro TAKAKI, Nisshin-city (JP); Fumiaki ARIKAWA, Nisshin-city (JP); Tomoki FUJINO, Kariya-city (JP)

(73) Assignee: DENSO CORPORATION, Kariya-city (JP)

(21) Appl. No.: 16/665,579

(22) Filed: Oct. 28, 2019

Related U.S. Application Data
(63) Continuation of application No. PCT/JP2018/010587, filed on Mar. 16, 2018.

(30) Foreign Application Priority Data
Apr. 28, 2017 (JP) 2017-090295

(51) Int. Cl. F02M 61/10; F02M 51/06

(52) U.S. Cl. CPC F02M 61/10; F02M 51/06

(57) ABSTRACT

A fuel injection valve includes a fixed core and a movable core. The fixed core includes a fixed-side high rigidity portion having high rigidity and a fixed-side low rigidity portion having rigidity lower than that of the fixed-side high rigidity portion. The movable core includes a movable-side high rigidity portion having high rigidity and a movable-side low rigidity portion having rigidity lower than that of the movable-side high rigidity portion. Current fed to a coil generates a magnetic attractive force to cause the movable core to move toward the fixed core together with a needle and to cause the movable-side high rigidity portion to abut on the fixed-side high rigidity portion.

### CROSS-REFERENCE TO RELATED APPLICATION

The present application is based on and claims the benefit of priority from earlier Japanese Patent Application No. 2017-090295 filed Apr. 28, 2017, the whole description of which is incorporated herein by reference.

### BACKGROUND

### Technical Field

The present disclosure relates to a fuel injection valve.

### Related Art

As a fuel injection valve installed in an internal combustion engine, there is known a fuel injection valve which is configured to activate a movable core inside the valve together with a needle by a magnetic attractive force to open or close an injection port that is an exit of fuel.

### SUMMARY

As an aspect of the present disclosure, a fuel injection valve includes: a housing that has an end in a longitudinal direction at which an injection port for injecting fuel is formed; a needle that opens or closes the injection port by moving inside the housing in the longitudinal direction; a fixed core that is a member having at least a part made of a magnetic material and is fixed to the inside of the housing; a movable core that is a member having at least a part made of a magnetic material and is disposed in a state of being movable together with the needle in the longitudinal direction inside the housing; and a coil that generates a magnetic attractive force between the fixed core and the movable core. The fixed core includes a fixed-side high rigidity portion having high rigidity and a fixed-side low rigidity portion having rigidity lower than that of the fixed-side high rigidity portion. The movable core includes a movable-side high rigidity portion having high rigidity and a movable-side low rigidity portion having rigidity lower than that of the movable-side high rigidity portion. When current is fed to the coil, the movable core moves toward the fixed core together with the needle by the generated magnetic attractive force and the movable-side high rigidity portion abuts on the fixed-side high rigidity portion.

### BRIEF DESCRIPTION OF THE DRAWINGS

In the accompanying drawings:

FIG. 1 is a cross-sectional view illustrating an internal structure of a fuel injection valve according to a first embodiment.

FIG. 2 is a cross-sectional view illustrating an internal structure of a fuel injection valve according to a second embodiment.

FIG. 3 is a cross-sectional view illustrating an internal structure of a fuel injection valve according to a third embodiment.

FIG. 4 is a cross-sectional view illustrating an internal structure of a fuel injection valve according to a fourth embodiment.

FIG. 5 is a cross-sectional view illustrating an internal structure of a fuel injection valve according to a fifth embodiment.

FIG. 6 is an enlarged view illustrating the configuration of a movable core and the vicinity thereof illustrated in FIG. 5.

FIG. 7 is a cross-sectional view illustrating an internal structure of a fuel injection valve according to a sixth embodiment.

### DETAILED DESCRIPTION OF THE PREFERRED EMBODIMENTS

As a fuel injection valve installed in an internal combustion engine, there is known a fuel injection valve which is configured to activate a movable core inside the valve together with a needle by a magnetic attractive force to open or close an injection port that is an exit of fuel.

For example, the fuel injection valve described in the following JP 2013-100756A includes a fixed core that is fixed to the interior of the a housing, a movable core that is disposed in a movable state in the interior of the housing, and a coil that generates a magnetic attractive force between the fixed core and the movable core. At the time of injecting fuel from the fuel injection valve, current is fed to the coil. The magnetic attractive force generated then causes the movable core to move toward the fixed core together with the needle to open the injection port.

In a fuel injection valve, deformation of the components, such as a fixed core, due to abrasion or damage may vary characteristics such as of fuel injection quantity. Therefore, in a fuel injection valve, it is necessary that abrasion or damage of the components are minimized as much as possible.

The fixed core of the fuel injection valve mentioned above is provided with a bush which is made of a material having relatively high rigidity. The needle is not in direct contact with the fixed core but moves in a state of being in contact with the bush. Thus, the fixed core, which is made of a magnetic material having relatively low rigidity, is prevented from being worn out due to the sliding contact with the needle.

As mentioned above, when fuel is injected from the fuel injection valve, the movable core moves toward the fixed core. In this case, the movement of the movable core is finally stopped by being brought into contact with the bush provided to the fixed core instead of being brought into contact with the fixed core. In the fuel injection valve mentioned above, since the movable core does not directly collide against the fixed core, abrasion or damage of the fixed core is even more minimized.

In the fuel injection valve described in JP 2013-100756A, the movable core which is made of a material having relatively low rigidity collides against the bush which is made of a material having relatively high rigidity. Therefore, there is a concern that the movable core may be damaged by the collision. In particular, if a gas fuel is used as fuel to be injected, the moving speed of the movable core becomes higher due to the low viscosity of the fuel. Therefore, there is a higher probability of the movable core being damaged due to the collision. To maintain the performance characteristics of a fuel injection valve over a long time period, it is desirable to prevent damage to not only the fixed core but also the movable core.

The present disclosure aims to provide a fuel injection valve capable of preventing damage of a fixed core and a movable core.

With reference to the accompanying drawings, embodiments will be described. For the sake of clarity, the components identical with or similar to each other between the drawings are given the same reference signs as much as possible to omit duplicate description.

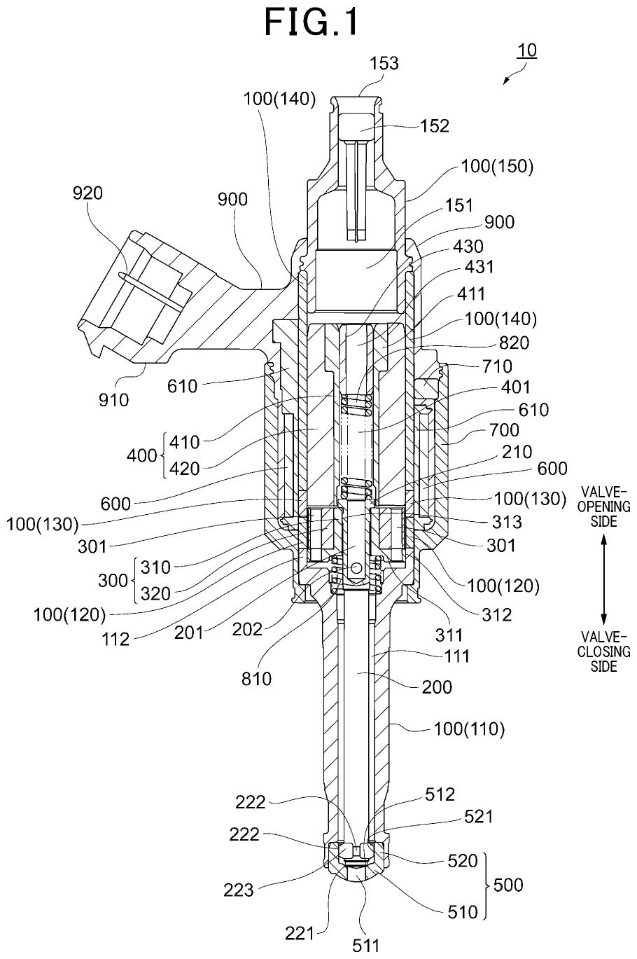

Referring to FIG. 1, the configuration of a fuel injection valve 10 according to a first embodiment will be described. The fuel injection valve 10 is a device installed in an internal combustion engine, not shown, to supply fuel to the internal combustion engine. The fuel injection valve 10 includes a housing 100, a needle 200, a movable core 300, a fixed core 400 and a coil 600.

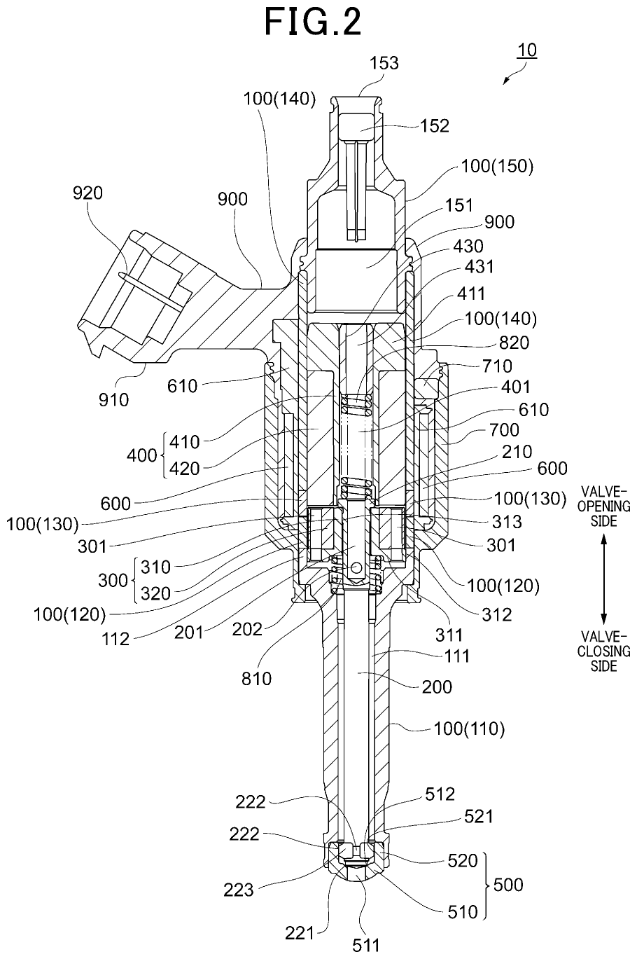

The housing 100 is a member the entirety of which is formed as a substantially cylindrical container. In FIG. 1, the housing 100 is illustrated so that its longitudinal direction matches the vertical direction. It should be noted that a term “upper side” or the like may be simply used to indicate an upper part of FIG. 1. Also, a term “lower side” or the like may be simply used to indicate a lower part of FIG. 1. The same applies to FIGS. 2 to 7.

As will be described later, in the housing 100, the fuel injected from the fuel injection valve 10 flows from the upper side toward the lower side. The needle 200, the movable core 300, and the fixed core 400, which will be described later, are all held inside the housing 100.

The housing 100 includes a first cylindrical member 110, a second cylindrical member 120, a third cylindrical member 130, a fourth cylindrical member 140, and a fifth cylindrical member 150. These members are all formed as substantially cylindrical members with the axes thereof being aligned with each other.

The first cylindrical member 110 is disposed most downstream of the housing 100 along the fuel flow direction. The first cylindrical member 110 is made of martensitic stainless steel and subjected to quenching treatment to enhance rigidity. The first cylindrical member 110 defines a space 111 on the inside thereof for holding the needle 200 described later.

The first cylindrical member 110 has a lower end portion into which an injection nozzle 500 is press-fitted and welded. The injection nozzle 500 forms a part of the housing 100 and includes a cylindrical portion 520 and a choke portion 510. The cylindrical portion 520 is formed into a cylindrical shape. The cylindrical portion 520 is fitted into the first cylindrical member 110 in a state where the center axis of the former aligns with that of the latter. The cylindrical portion 520 has an inner peripheral surface 521 over which sliding contact portions 222 (described later) of the needle 200 slide in a state of being in contact therewith.

The choke portion 510 is formed so as to close the lower side end portion of the cylindrical portion 520. The choke portion 510 is provided with an injection port 511. The injection port 511 is a through hole which is formed so as to pass through the center of the choke portion 510 in the vertical direction of FIG. 1. The injection port 511 allows communication between the internal space 111 of the first cylindrical member 110 and the external space. The injection port 511 is formed so as to serve as an exit of fuel to be injected from the fuel injection valve 10. Thus, in the fuel injection valve 10, the injection port 511 for injecting fuel is formed at a longitudinal end of the housing 100.

The choke portion 510 has an inner surface on which a valve seat 512 is formed so as to surround the injection port 511. The valve seat 512 serves as a part on which a sealing portion 221 (described later) of the needle 200 is abutted to close the injection port 511.

The injection nozzle 500 is made of martensitic stainless steel and subjected to quenching treatment to enhance rigidity. Of the injection nozzle 500, the part on which the needle 200 is abutted, i.e., the valve seat 512, and the inner peripheral surface 521 are subjected to nitriding treatment. The inner peripheral surface 521 is further provided with a DLC coating to reduce frictional force.

Of the first cylindrical member 110, a portion opposite to the injection nozzle 500 (i.e., the upper side) has a larger diameter. This portion is further extended toward the upper side, while forming a large diameter cylindrical portion 112. The large diameter cylindrical portion 112 has an inner surface over which a part of the movable core 300 slides in a state of being in contact therewith as will be described later. Therefore, the large diameter cylindrical portion 112 is subjected to nitriding treatment. The upper end of the large diameter cylindrical portion 112 (i.e., the upper end of the first cylindrical member 110) is connected to the lower end of the second cylindrical member 120.

The second cylindrical member 120 of the housing 100 is disposed upstream of the first cylindrical member 110 along the fuel flow direction. The second cylindrical member 120 has inner and outer diameters which are respectively equal to those of the large diameter cylindrical portion 112. The second cylindrical member 120 is made of ferrite stainless steel which is a magnetic material. The upper end of the second cylindrical member 120 is connected to the lower end of the third cylindrical member 130.

The third cylindrical member 130 of the housing 100 is disposed upstream of the second cylindrical member 120 along the fuel flow direction. The third cylindrical member 130 has inner and outer diameters which are respectively equal to those of the second cylindrical member 120. The third cylindrical member 130 is made of austenitic stainless steel which is a non-magnetic material. The upper end of the third cylindrical member 130 is connected to the lower end of the fourth cylindrical member 140.

The fourth cylindrical member 140 of the housing 100 is disposed upstream of the third cylindrical member 130 along the fuel flow direction. The fourth cylindrical member 140 has inner and outer diameters which are respectively equal to those of the third cylindrical member 130. The fourth cylindrical member 140 is made of ferrite stainless steel which is a magnetic material. The fourth cylindrical member 140 has an upper side portion into which a lower end portion of the fifth cylindrical member 150 is press-fitted and welded.

The fifth cylindrical member 150 is disposed most upstream of the housing 100 along the fuel flow direction. The fifth cylindrical member 150 is made of austenitic stainless steel. The fifth cylindrical member 150 has an upper end portion at which an inlet port 153 is formed. The inlet port 153 is an opening that serves as an entrance of the fuel externally introduced.

The fifth cylindrical member 150 defines a space 151 on the inside thereof. The space 151 is provided with a filter 152 at a position near the inlet port 153. The filter 152 captures foreign matter which is contained in the fuel introduced from the inlet port 153.

The needle 200 is a rod-like member disposed inside the housing 100. The needle 200 is disposed so as to be movable in the longitudinal direction of the housing 100 (vertical direction of FIG. 1), with the center axis of the needle 200 being aligned with that of the housing 100. The needle 200 is made of martensitic stainless steel and subjected to quenching treatment to enhance rigidity. The needle 200 has an injection nozzle 500-side end portion at which a sealing portion 221 is formed.

When the needle 200 moves to the lowermost side in the movable range, the sealing portion 221 abuts on the valve seat 512, as shown in FIG. 1, to close the injection port 511. Thus, fuel injection from the injection port 511 is stopped. When the needle 200 moves toward the upper side and the sealing portion 221 separates from the valve seat 512, the injection port 511 opens. Thus, fuel is injected from the injection port 511. In this way, the needle 200 is provided as a member for opening or closing the injection port 511 with the longitudinal movement on the inside of the housing 100.

In the following description, a term “valve-opening side” may be used for indicating a side toward which the needle 200 moves, i.e., the upper side of FIG. 1, to open the injection port 511. Also, a term “valve-closing side” may be used for indicating a side toward which the needle 200 moves, i.e., the lower side of FIG. 1, to close the injection port 511.

The needle 200 has a side face on which a plurality of sliding contact portions 222 are formed which protrudes outward, at a level that is slightly on the valve-opening side relative to the sealing portion 221. The sliding contact portions 222 slide over the inner peripheral surface 521 of the cylindrical portion 520 with the outermost ends thereof being in contact with the inner peripheral surface 521. The plurality of sliding contact portions 222 are formed so as to be juxtaposed in the circumferential direction of the needle 200. Between adjacent sliding contact portions 222, there is provided a recess 223 as a passage of fuel. Of the needle 200, the sealing portion 221 and the sliding contact portions 222 are subjected to nitriding treatment. The sliding contact portions 222 are each further provided with a DLC coating. Thus, frictional resistance is reduced between each sliding contact portion 222 and the inner peripheral surface 521.

The needle 200 is disposed in a state of vertically passing through the movable core 300 described later. The needle 200 has an upper end portion which is located at further upper side than the upper end of the movable core 300. The upper end portion of the needle 200 has a side face on which a large diameter portion 210 is formed protruding outward. The large diameter portion 210 has a movable core 300-side (valve-closing side) surface which abuts on an end face of the movable core 300.

The needle 200 defines a space 201 on the inside thereof. The space 201 is formed so as to extend from a valve-opening side end portion of the large diameter portion 210 of the needle 200 to a position that is on a further valve-closing side than the movable core 300. At the valve-opening side end portion of the needle 200, the space 201 is permitted to communicate with the outside. At a position of the space 201 which is on a further valve-closing side than the movable core 300, the needle 200 is provided with a through hole 202. The through hole 202 establishes communication between the space 201 and the space 111.

The movable core 300 is a member the entirety of which is formed into a substantially columnar shape. The movable core 300 is disposed so as to be movable in the longitudinal direction of the housing 100 (vertical direction in FIG. 1) together with the needle 200, with the center axis of the movable core 300 being aligned with that of the housing 100. The movable core 300 includes a movable-side high rigidity portion 310 and a movable-side low rigidity portion 320.

The movable-side high rigidity portion 310 is in a substantially cylindrical shape and a part of which (a part except a large diameter portion 311 described later) is disposed inside the movable-side low rigidity portion 320. The movable-side high rigidity portion 310 is made of a non-magnetic material which is martensitic stainless steel having relatively high rigidity. The movable-side high rigidity portion 310 is subjected to quenching treatment to enhance rigidity. The movable-side high rigidity portion 310 has a center portion through which a movable-side through hole 313 is formed in the vertical direction (i.e., the longitudinal direction of the housing 100). The needle 200 described above is inserted into the movable-side through hole 313. The outer surface of the needle 200 is slidable over the inner surface of the movable-side through hole 313 in a state of being in contact therewith. The inner surface of the movable-side through hole 313 is subjected to nitriding treatment. The outer surface of the needle 200 is also subjected to nitriding treatment and is further provided with a DLC coating.

The movable-side high rigidity portion 310 has a valve-opening side end face on which the large diameter portion 210 of the needle 200 is abutted from the upper side. As will be described later, a part of the valve-opening side end face of the movable-side high rigidity portion 310 abuts on the fixed core 400 when the valve is opened. The valve-opening side end face of the movable-side high rigidity portion 310 is subjected to nitriding treatment at respective parts on which the large diameter portion 210 of the needle 200 and the fixed core 400 are abutted. The large diameter portion 210 has a valve-closing side end face which is also subjected to nitriding treatment.

The movable-side high rigidity portion 310 has a valve-closing side portion which is increased in diameter to form a large diameter portion 311 protruding outward. The large diameter portion 311 has an outermost surface 312 contacting the inner surface of the large-diameter cylindrical portion 112 of the first cylindrical member 110. When the movable core 300 moves, the outermost surface 312 of the large diameter portion 311 slides over the inner surface of the large diameter cylindrical portion 112 in a state of being in contact therewith. The outermost surface 312 is subjected to nitriding treatment and is further provided with a DLC coating.

The movable-side low rigidity portion 320 is in a substantially cylindrical shape and is disposed on the outside of the movable-side high rigidity portion 310. The movable-side low rigidity portion 320 is fixed to the movable-side high rigidity portion 310 by so-called “hammering” in a state in which the inner surface of the former is in contact with the outer surface of the latter. The movable-side low rigidity portion 320 has a valve-closing side end face abutting on the large diameter portion 311 of the movable-side high rigidity portion 310.

The movable-side low rigidity portion 320 is made of ferrite stainless steel which is a magnetic material. Thus, the movable-side low rigidity portion 320 is lower in rigidity than the movable-side high rigidity portion 310. In the housing 100, the movable-side low rigidity portion 320 is disposed so as to mostly face the second cylindrical member 120.

The movable-side low rigidity portion 320 has a valve-opening side end face which is at a level slightly closer to the valve-closing side than the valve-opening side end face of the movable-side high rigidity portion 310 is. In other words, the upper end face of the movable-side high rigidity portion 310 slightly protrudes toward the upper side (fixed core 400 side) compared with the upper end face of the movable-side low rigidity portion 320.

Thus, the movable-side high rigidity portion 310 is formed so as to extend from an end (i.e., the upper end portion) of the movable core 300 to the other end (i.e., the lower end portion) thereof in the longitudinal direction of the housing 100.

Near the outer periphery of the movable core 300, a plurality of through holes 301 are formed passing through the movable core 300 in the vertical direction. Each through hole 301 is formed so as to pass through both the large diameter portion 311 of the movable-side high rigidity portion 310 and the movable-side low rigidity portion 320. Functions of the through holes 301 will be described later.

As described above, in the present embodiment, the movable-side low rigidity portion 320 that is a part of the movable core 300 is made of a magnetic material, while the movable-side high rigidity portion 310 that is the other part is made of a non-magnetic material. Alternative to such a mode, the movable core 300 may be entirely made of a magnetic material. In this alternative mode as well, the movable-side high rigidity portion 310 is made of a material whose rigidity is higher than that of the material used for the movable-side low rigidity portion 320.

The fixed core 400 is a member the entirety of which is formed into a substantially columnar shape as in the movable core 300. The fixed core 400 is fixed to the interior of the housing 100 with the center axis of the former being aligned with that of the latter. The fixed core 400 is disposed so as to be adjacent, on the valve-opening side, to the movable core 300. As shown in FIG. 1, in a state in which the sealing portion 221 of the needle 200 abuts on the valve seat 512, there is a gap formed between the fixed core 400 and the movable core 300. The fixed core 400 includes a fixed-side high rigidity portion 410 and a fixed-side low rigidity portion 420.

The fixed-side high rigidity portion 410 is in a substantially cylindrical shape and is disposed inside the fixed-side low rigidity portion 420. The fixed-side high rigidity portion 410 is made of a martensitic stainless steel which is a non-magnetic material and has relatively high rigidity. The fixed-side high rigidity portion 410 is subjected to quenching treatment to enhance rigidity. The fixed-side high rigidity portion 410 has a movable core 300-side end face on which the movable-side high rigidity portion 310 of the movable core 300 abuts. Therefore, this end face is subjected to nitriding treatment.

The fixed-side high rigidity portion 410 has a center portion through which a fixed-side through hole 401 is formed in the vertical direction (i.e., the longitudinal direction of the housing 100). The space 201 of the needle 200 described above is permitted to communicate with the space 151 of the fifth cylindrical member 150 via the fixed-side through hole 401. The upper end portion of the fixed-side high rigidity portion 410 has a side face on which a large diameter portion 411 is formed so as to protrude outward.

The fixed-side through hole 401 has a movable core 300 side portion through which the large diameter portion 210 of the needle 200 is inserted from the lower side. As shown in FIG. 1, in this portion of the fixed-side through hole 401, the inner diameter is made larger than that of the remaining portion of the fixed-side through hole 401. Therefore, there is a gap formed between the large diameter portion 210 of the needle 200 and the inner surface of the fixed-side through hole 401.

The fixed-side low rigidity portion 420 is in a substantially cylindrical shape and the entirety of which is disposed on the outside of the fixed-side high rigidity portion 410. The fixed-side low rigidity portion 420 is fixed to the fixed-side high rigidity portion 410 by welding in a state in which the inner surface of the former is in contact with the outer surface of the latter. In the present embodiment, the fixed-side high rigidity portion 410 and the fixed-side low rigidity portion 420 are welded to each other at the level of the valve-opening side end portion of the fixed core 400.

The fixed-side low rigidity portion 420 is made of ferrite stainless steel which is a magnetic material. Thus, the fixed-side low rigidity portion 420 is lower in rigidity than the fixed-side high rigidity portion 410. In the housing 100, the fixed-side low rigidity portion 420 is disposed so as to mostly face the fourth cylindrical member 140. The fixed-side low rigidity portion 420 has an outer surface which is welded and fixed to the inner surface of the fourth cylindrical member 140.

The fixed-side low rigidity portion 420 has a valve-opening side end face which is flush with the valve-opening side end face of the fixed-side high rigidity portion 410. The fixed-side low rigidity portion 420 has a valve-closing side end face which is at a level slightly closer to the valve-opening side than the valve-closing side end face of the fixed-side high rigidity portion 410 is. In other words, the lower end face of the fixed-side high rigidity portion 410 slightly protrudes toward the lower side (movable core 300 side) compared to the lower end face of the fixed-side low rigidity portion 420.

Thus, the fixed-side high rigidity portion 410 is formed so as to extend from an end (i.e., the upper end portion) of the fixed core 400 to the other end (i.e., the lower end portion) thereof in the longitudinal direction of the housing 100. The lower end face of the fixed-side high rigidity portion 410 entirely faces the upper end face of the movable-side high rigidity portion 310.

As described above, in the present embodiment, the fixed-side low rigidity portion 420 that is a part of the fixed core 400 is made of a magnetic material, while the fixed-side high rigidity portion 410 that is the other part is made of a non-magnetic material. Alternative to such a mode, the fixed core 400 may be entirely made of a magnetic material. In this alternative mode as well, the fixed-side high rigidity portion 410 is made of a material whose rigidity is higher than that of the material used for the fixed-side low rigidity portion 420.

The coil 600 generates a magnetic force with current being fed. The coil 600 is wound about a bobbin 610 and disposed in this state covering the entire third cylindrical member 130 and a part of the fourth cylindrical member 140 of the housing 100 from outside. When current is fed to the coil 600, a magnetic circuit is formed such that a magnetic flux passes through the fixed-side low rigidity portion 420, the movable-side low rigidity portion 320, the second cylindrical member 120, the fourth cylindrical member 140, and the like. As a result of this, a magnetic attractive force is generated between the fixed core 400 and the movable core 300. The magnetic attractive force causes the movable core 300 to move toward the valve-opening side together with the needle 200. When the current feeding to the coil 600 is stopped, the magnetic attractive force becomes zero. In this case, the movable core 300 moves toward the valve-closing side together with the needle 200, being urged by a spring 820 described later.

The remaining configuration of the fuel injection valve 10 will be described. The fixed-side through hole 401 formed in the fixed-side high rigidity portion 410 has an upper side portion into which an adjusting pipe 430 is press fitted. The adjusting pipe 430 is a cylindrical member and has a through hole 431 formed therethrough in the vertical direction.

The fixed-side through hole 401 is provided with a sprint 820 located at a lower side of the adjusting pipe 430. The spring 820 is an elastic member that expands and contracts in the vertical direction. An end of the spring 820 abuts on the valve-closing side end portion of the adjusting pipe 430. The other end of the spring 820 abuts on the valve-opening end portion of the large diameter portion 210 of the needle 200. The spring 820 is provided in a state in which the length is made smaller than the free length. Therefore, the large diameter portion 210 of the needle 200 is pressed against the movable-side high rigidity portion 310 by the force of the spring 820. Consequently, the sprint 820 urges both the needle 200 and the movable core 300 toward the valve-closing side.

At the lower side of the movable core 300, there is provided a spring 810. The spring 810 is an elastic member that expands and contracts in the vertical direction. An end of the spring 810 abuts on a step portion which is formed in a valve-closing side end face of the movable-side high rigidity portion 310. The other end of the spring 810 abuts on a step portion which is formed near the valve-opening side end portion of the first cylindrical member 110.

The spring 810 is provided in a state in which the length is made smaller than the free length. Therefore, the movable-side high rigidity portion 310 of the movable core 300 is pressed against the large diameter portion 210 of the needle 200 by the force of the spring 810. Consequently, the spring 810 urges both the needle 200 and the movable core 300 toward the valve-opening side. Provision of the springs 810 and 820 maintains the state of the large diameter portion 210 and the movable-side high rigidity portion 310 being abutted on each other.

In the present embodiment, the urging force of the spring 820 is ensured to be larger than that of the spring 810. Accordingly, when the current feeding to the coil 600 is stopped and no magnetic attractive force is generated between the fixed core 400 and the movable core 300, the sealing portion 221 of the needle 200 is brought into a state of abutting on the valve seat 512, i.e., a state of closing the injection port 511.

The coil 600, the fourth cylindrical member 140 and a part of the fifth cylindrical member 150 are molded with a resin 900 from outside. A part of the resin 900 is protruded outward and this protruded portion is formed into a connector 910. The connector 910 serves as a portion to be connected to a line for feeding current to the coil 600. The connector 910 has an interior where a feed terminal 920 is disposed. The feed terminal 920 is provided at an end of the feed line connected to the coil 600. Current is fed to the coil 600 from the feed terminal 920.

Of the resin 900, a portion molding the fourth cylindrical member 140 is provided with a holder 700 to cover this portion from outside. The holder 700 is a cylindrical member made of a magnetic material extending from outside the large diameter cylindrical portion 112 to a further valve-opening side level than a valve-opening side end portion of the coil 600. On the inside of the holder 700, there is provided a cover 710 at a further valve-opening side level than the coil 600. The cover 710 is a substantially circular pipe member made of a magnetic material and disposed so as to surround the fourth cylindrical member 140. Of the cover 710, a portion near the connector 910 is notched to avoid interference with the connector 910. Accordingly, in FIG. 1, a cross section of the cover 710 appears only at a right side position of the fourth cylindrical member 140. The holder 700 and the cover 710 form a part of the magnetic circuit through which a magnetic flux generated by the coil 600 passes.

Operation of the fuel injection valve 10 will be described. Fuel is supplied to the fifth cylindrical member 150 from the inlet port 153. When current is not fed to the coil 600, the injection port 511 is closed as described above. Therefore, the interior of the fuel injection valve 10 is pressurized by the fuel.

When current is started to be fed to the coil 600, the magnetic attractive force generated between the fixed core 400 and the movable core 300 causes the movable core 300 to move toward the valve-opening side. In this case, the needle 200 also moves toward the valve-opening side together with the movable core 300 because the large diameter portion 210 of the needle 200 is in contact with the movable-side high rigidity portion 310 of the movable core 300. With the separation of the sealing portion 221 of the needle 200 from the valve seat 512 to open the injection port 511, fuel injection from the injection port 511 is started.

Fuel flows into the space 151 from the inlet port 153 and then sequentially flows through the through hole 431, the fixed-side through hole 401, the space 201, the through hole 202 and the space 111, for injection from the injection port 511.

The region surrounding the movable core 300 is filled with the fuel discharged from the through hole 202. When the movable core 300 moves toward the valve-opening side, the fuel which has been in a space at a further valve-opening side than the movable core 300 flows through the through hole 301 of the movable core 300 into a space at a further valve-closing side than the movable ore 300. Since the fuel smoothly moves through the through hole 301, movement of the movable core 300 is not prevented by the fuel. The same applies to the case where the movable core 300 moves thereafter toward the valve-closing side.

The movable core 300 that has started moving toward the valve-opening side then abuts on the fixed core 400 and stops. As described above, in the present embodiment, the upper end face of the movable-side high rigidity portion 310 protrudes toward the fixed core 400, and the lower end face of the fixed-side high rigidity portion 410 protrudes toward the movable core 300. Therefore, the movable-side high rigidity portion 310 of the movable core 300 abuts on the fixed core 400, but the movable-side low rigidity portion 320 thereof does not abut on the fixed core 400. Also, the movable core 300 abuts on the fixed side high rigidity portion 410 of the fixed core 400, but the movable core 300 does not abut on the fixed-side low rigidity portion 420.

Thus, the fuel injection valve 10 of the present embodiment is configured such that current fed to the coil 600 generates a magnetic attractive force to cause the movable core 300 to move toward the fixed core (toward the valve-opening side) together with the needle 200 and to cause the movable-side high rigidity portion 310 to abut on the fixed-side high rigidity portion 410.

In the present embodiment, a portion having relatively high rigidity of the movable core 300 (movable-side high rigidity portion 310) collides with a portion having relatively high rigidity of the fixed core 400 (fixed-side high rigidity portion 410). Therefore, damage due to the collision is reduced or prevented in both the fixed core and the movable core.

The movable-side low rigidity portion 320 and the fixed-side low rigidity portion 420, which are the portions contributing to generating a magnetic attractive force and each made of a magnetic material having relatively low rigidity, are configured not to collide with other members. The fuel injection valve 10 is configured to efficiently generate a magnetic attractive force using magnetic materials, while being configured to reduce or prevent damage due to collision between the magnetic materials.

The movable-side high rigidity portion 310 is formed so as to extend from an end (i.e., the upper end portion) of the movable core 300 to the other end (i.e., the lower end portion) thereof in the longitudinal direction of the housing 100. Therefore, when the movable core 300 abuts on the fixed core 400, the impact applied to the movable-side low rigidity portion 320 is reduced, compared, for example, to the configuration in which the valve-closing side end portion of the movable-side high rigidity portion 310 is supported by the movable-side low rigidity portion 320. Accordingly, the movable-side low rigidity portion 320 having low rigidity is further prevented from being damaged.

Similarly, the fixed-side high rigidity portion 410 is formed so as to extend from an end (i.e., the upper end portion) of the fixed core 400 to the other end (i.e., the lower end portion) thereof in the longitudinal direction of the housing 100. Therefore, when the movable core 300 abuts on the fixed core 400, the impact applied to the fixed-side low rigidity portion 420 is reduced, compared, for example, to the configuration in which the valve-opening side end portion of the fixed-side high rigidity portion 410 is supported by the fixed-side low rigidity portion 420. Accordingly, the fixed-side low rigidity portion 420 having low rigidity is further prevented from being damaged.

When the current feeding to the coil 600 is stopped in a state in which the injection port 511 is open, the magnetic attractive force no longer works between the fixed core 400 and the movable core 300. The movable core 300 and the needle 200 are urged by the spring 820 and move toward the valve-closing side and finally create a state in which the sealing portion 211 is in contact with the valve seat 512, i.e., a state in which the injection port 151 is closed. Thus, fuel injection from the injection port 511 stops.

In the present embodiment, the fixed-side high rigidity portion 410 is disposed inside the fixed-side low rigidity portion 420, and the movable-side high rigidity portion 310 is disposed inside the movable-side low rigidity portion 320. In such a configuration, the movable core 300 is provided with the movable-side trough hole 313 passing through the center portion of the movable-side high rigidity portion 310 in the longitudinal direction, with the needle 200 being inserted into the movable-side through hole 313. Accordingly, since the needle 200 is in contact with only a high rigidity portion of the movable core 300 and slides thereover, abrasion of the movable core 300 is minimized. Consequently, the performance characteristics of the fuel injection valve 10 are further prevented from being varied in a short period of time due to deformation of the movable core 300.

In the present embodiment, the large diameter portion 311 of the movable-side high rigidity portion 310 is configured to slide over the inner surface of the housing 100 (specifically, the inner surface of the large diameter cylindrical portion 112) in a state of being in contact therewith. Accordingly, abrasion of the movable core 300 is minimized, compared to the configuration in which the movable-side low rigidity portion 320 having low rigidity is configured to be in contact with the inner surface of the housing 100 and slide thereover. Consequently, the performance characteristics of the fuel injection valve 10 are further prevented from being varied in a short time period due to deformation of the movable core 300.

The present embodiment includes a pair of members (hereinafter, one is termed first member and the other is termed second member) which slide over each other in a state of being in contact with each other with the movement of the movable core 300 and the needle 200. Of these members, at least one is subjected to a treatment of imparting high rigidity (specifically, quenching or nitriding treatment) and a surface treatment of reducing frictional force (specifically, DLC coating). Thus, damage to or deformation of the movable core 300 or the fixed core 400 due to the sliding motion is further minimized.

Such a pair of first and second members may be the needle 200 and the injection nozzle 500, the needle 200 and the movable-side high rigidity portion 310, or the first cylindrical member 110 and the movable-side high rigidity portion 310. In the present embodiment, for all the paired portions sliding over each other in a state of being in contact with each other, at least one of each paired portions is subjected to the high rigidity imparting treatment or the surface treatment mentioned above.

The high rigidity imparting treatment may be applied to one of the first and second members or may be applied to both of them. In a mode, first and second members not subjected to the high rigidity imparting treatment may be provided to a part of the fuel injection valve 10.

Similarly, the surface treatment for reducing frictional force may be applied to one of the first and second members or may be applied to both of them. In a mode, first and second members not subjected to the surface treatment for reducing frictional force may be provided to a part of the fuel injection valve 10.

The treatment for imparting high rigidity may be quenching or nitriding treatment as in the present embodiment, but a treatment other than quenching or nitriding treatment may be used. The surface treatment for reducing frictional force may be DLC coating as in the present embodiment, but may be a treatment other than DLC coating.

Referring to FIG. 2, a second embodiment will be described. The following description mainly describes differences from the first embodiment. Description of matters common to the first embodiment will be omitted as appropriate.

In a fuel injection valve 10 of the present embodiment, the valve-opening side portion of the fixed-side high rigidity portion 410 is provided with a large diameter portion 411 whose outermost surface is in contact with the inner surface of the fourth cylindrical member and is fixed thereto by welding. In the present embodiment, the outer side surface of the fixed-side low rigidity portion 420 is slightly apart from the inner surface of the fourth cylindrical member 140 and are not welded to each other.

Thus, in the present embodiment, the large diameter portion 411 of the fixed-side high rigidity portion 410 is joined to the inner surface of the housing. In such a configuration, the impact caused when the movable core 300 has abutted on the fixed core 400 at the time of valve opening is directly applied only to the fixed-side high rigidity portion 410 and not applied to the fixed-side low rigidity portion 420. Accordingly, the fixed-side low rigidity portion 420 having low rigidity is further prevented from being damaged.

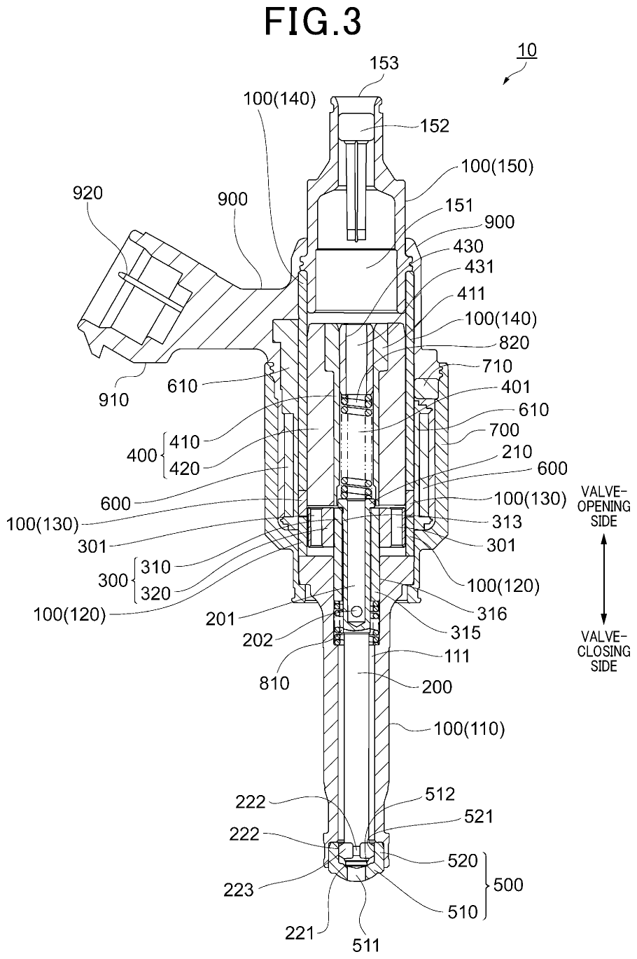

Referring to FIG. 3, a third embodiment will be described. The following description mainly describes differences from the first embodiment. Explanation on matters common to the first embodiment will be omitted as appropriate.

In a fuel injection valve 10 of the present embodiment, the movable-side high rigidity portion 310 is not provided with the large diameter portion 311. The movable-side high rigidity portion 310 in its entirety is formed into a cylindrical shape, with its valve-closing side end portion being extended further to the valve-closing side than the valve-closing side end portion of the movable-side low rigidity portion 320 is. Of the movable-side high rigidity portion 310, the portion extending further to the valve-closing side than the valve-closing side end portion of the movable-side low rigidity portion 320 is may be hereinafter also termed extended portion 315. The extended portion 315 is extended into the space 111 of the first cylindrical member 110. The extended portion 315 has a valve-closing side end portion which is located slightly toward the valve-opening side than the through hole 202. The valve-closing side end portion of the extended portion 315 abuts on an end portion of the spring 810.

The extended portion 315 has an outer side surface 316 which is ensured to slide over the inner surface of the first cylindrical member 110 defining the space 111, in a state of being in contact with the inner surface. Similarly to the outermost surface 312 of the first embodiment, the outer side surface 316 is subjected to nitriding treatment and is provided with a DLC coating. The inner surface of the first cylindrical member 110 facing the outer side surface 316 is subjected to nitriding treatment.

In such a mode, the portion of the movable core 300 whose sliding is guided, i.e., the extended portion 315, has a vertical length which is larger than that of the outermost surface 312 (first embodiment). Therefore, the movement of the movable core 300 at the time of valve opening or closing can be made more stable.

The first cylindrical member 110 of the present embodiment is not provided with the large diameter cylindrical portion 112 that circumferentially encloses the movable core 300. Instead, the second cylindrical member 120 is extended to the lower side. This is because, in the present embodiment, the portion with which the enlarged portion 311 of the movable-side high rigidity portion 310 contacts and slides over (i.e., the large diameter cylindrical portion 112) does not have to be provided near the second cylindrical member 120. In such a configuration, the extended second cylindrical member 120 can reduce magnetic resistance in this portion. Consequently, the magnetic attractive force generated between the fixed core 400 and the movable core 300 is increased so that valve-opening operation of the fuel injection valve can be efficiently performed.

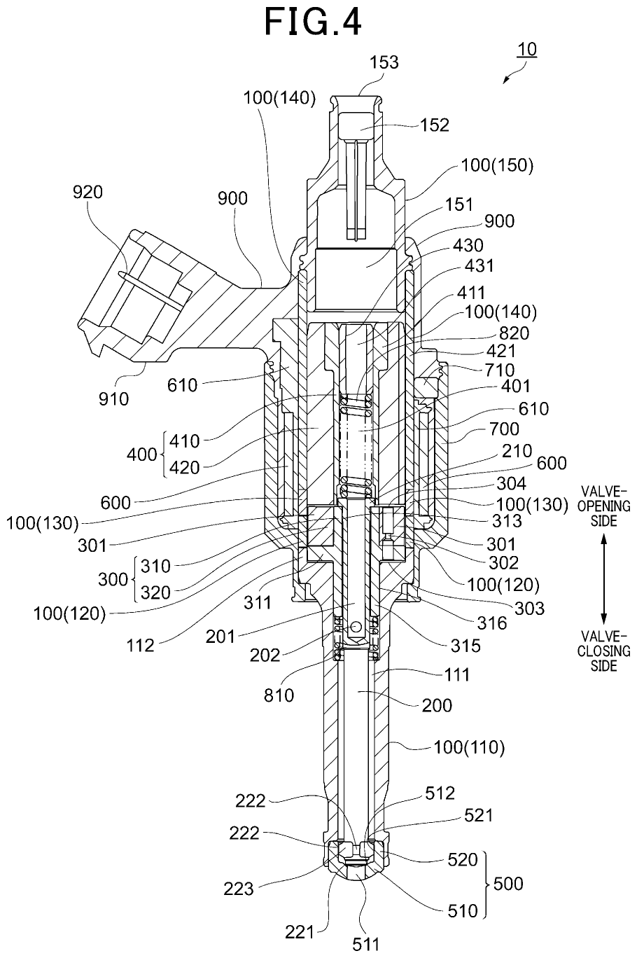

Referring to FIG. 4, a fourth embodiment will be described. The following description mainly describes differences from the first embodiment. Description of matters common to the first embodiment will be omitted as appropriate.

A fuel injection valve 10 of the present embodiment has a configuration in which a movable-side high rigidity portion 310 similar to that of the first embodiment is provided with an extended portion 315 similar to that of the third embodiment (FIG. 3). Specifically, the movable-side high rigidity portion 310 of the present embodiment is in contact with the first cylindrical member 110 at two surfaces, i.e., the outermost surface 312 of the large diameter portion 311 and the outer side surface 316 of the extended portion 315, for sliding movement.

At a further valve-closing side than the large diameter portion 311, there is provided a damper chamber 303 that is a space sandwiched between the large diameter portion 311 and the first cylindrical member 110. Furthermore, there is provided a space 304 between the movable core 300 and the fixed core 400. The damper chamber 303 and the space 304 are both filled with fuel. The damper chamber 303 and the space 304 communicate with each other via a through hole passed through the movable core 300. The through hole 301 of the present embodiment is provided with an orifice 302 which throttles the through hole 301 to reduce the cross section of the fuel passage.

The fixed-side low rigidity portion 420 has an outer peripheral surface in which a communication path 421 that is a vertically extending slit-like groove is formed. The communication path 421 allows communication between the valve-closing side space 304 and the valve-opening side space 151. Thus, regardless of the operating state or the position of the movable core 300, fuel pressure in the space 304 is mostly constant.

When current is started to be fed to the coil 600 and the movable core 300 moves toward the valve-opening side, the fuel that has been in the space 304 flows into the damper chamber 303 via the through hole 301 and the orifice 302. If the moving speed of the movable core 300 becomes higher, the fuel flow described above is suppressed by the orifice 302. This minimizes the energy of collision between the movable-side high rigidity portion 310 and the fixed-side high rigidity portion 410 when the movable core 300 has reached the valve-opening side end portion.

When the current feeding to the coil 600 is stopped and the movable core 300 moves toward the valve-closing side, the fuel that has been in the damper chamber 303 flows into the space 304 via the through hole 301 and the orifice 302. If the moving speed of the movable core 300 becomes higher, the fuel flow mentioned above is suppressed by the orifice 302. This minimizes the energy of collision between the sealing portion 221 and the valve seat 512 when the movable core 300 has reached the valve-closing side end portion.

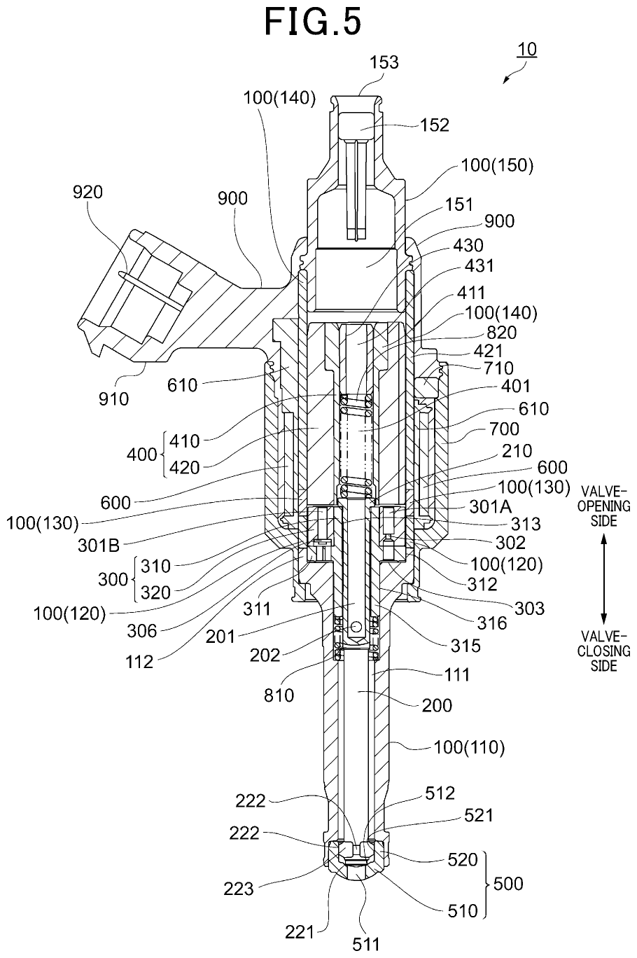

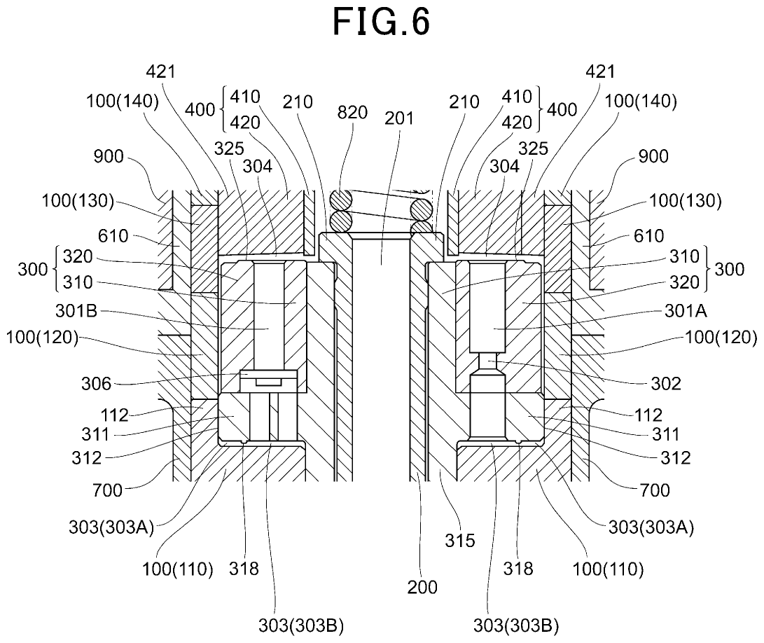

Referring to FIGS. 5 and 6, a fifth embodiment will be described. The following description mainly describes differences from the fourth embodiment (FIG. 4). Description of matters common to the fourth embodiment will be omitted as appropriate.

In the present embodiment, one through hole 301 is provided with an orifice 302 of the fourth embodiment and another through hole 301 is provided with a valve 306. The through hole 301 provided with the orifice 302 may also be termed through hole 301A hereinafter. The through hole 301 provided with the valve 306 may also be termed through hole 301B hereinafter.

The valve 306 is made movable in the vertical direction according to the flow or pressure of the fuel in the through hole 301B. The valve 306 inhibits fuel flow in the through hole 301B in the valve-opening direction, while allowing fuel flow therein in the valve-closing direction. In other words, the valve 306 serves as a so-called check valve.

When current is started to be fed to the coil 600 and the movable core 300 moves toward the valve-opening side, a part of the fuel that has been in the space 304 flows into the damper chamber 303 via the through hole 301A and the orifice 302. The remainder of the fuel (most of the fuel actually) that has been in the space 304 flows into the damper chamber 303 via the through hole 301B. Accordingly, at the time of valve opening, the provision of the orifice 302 is unlikely to contribute to decelerating the movable core 300.

When the current feeding to the coil 600 is stopped and the movable core 300 moves toward the valve-closing side, the fuel that has been in the damper chamber 303 flows into the space 304 via the through hole 301A and the orifice 302. The fuel flow toward the space 304 via the through hole 301B is inhibited by the valve 306. Accordingly, as in the fourth embodiment, the moving speed of the movable core 300 at the time of valve closing is decreased by the orifice 302.

Thus, in the present embodiment, the movable core 300 and the needle 200 promptly move in the valve-opening direction at the time of valve opening, and the moving speed of the both is decreased by the orifice 302 at the time of valve closing. Such a configuration is preferable if even more importance is placed on minimizing the energy of collision between the sealing portion 221 and the valve seat 512 than on minimizing the energy of collision between the movable-side high rigidity portion 310 and the fixed-side high rigidity portion 410.

As shown in the enlarged view of FIG. 6, on the valve-opening side end face of the movable-side low rigidity portion 320, the portion around the through holes 301A and 301B is protruded toward the valve-opening side more than other portions. This protruded portion may also be termed bank portion 325 hereinafter. In a state in which the movable core 300 and the needle 200 are positioned at the valve-opening side end portion, i.e., in a state in which they are fully lifted, the gap between the movable core 300 and the fixed core 400 is designed to be about 10 μm at the bank portion 325 and about 50 μm around this portion.

When current is started to be fed to the coil 600 and the movable core 300 moves toward the valve-opening side, the distance between the bank portion 325 and the fixed core 400 becomes gradually smaller. When this distance becomes smaller than 50 μm, passage resistance working on the fuel that flows between the both rapidly increases and prevents the fuel flow into the through holes 301A and 301B from the space 304. Consequently, the moving speed of the movable core 300 is decreased immediately before completing valve opening. Accordingly, the energy of collision between the movable-side high rigidity portion 310 and the fixed-side high rigidity portion 410 is minimized.

As shown in the enlarged view of FIG. 6, on the valve-closing side end face of the large diameter portion 311, an annular portion entirely surrounding the through holes 301A and 301B from outside is formed so as to protrude toward the valve-closing side. This protruded portion may also be termed bank portion 318 hereinafter. Of the damper chamber 303, the space on the outside of the bank portion 318 may also be termed outer damper chamber 303A hereinafter. The space on the inside of the bank portion 318 may also be termed inner damper chamber 303B hereinafter.

When the current feeding to the coil 600 is stopped and the movable core 300 and the needle 200 move toward the valve-closing side, the distance between the bank portion 325 and the first cylindrical member 110 becomes gradually smaller. When this distance becomes smaller than 50 μm, passage resistance working on the fuel that flows between the both rapidly increases and prevents the fuel flow into the inner damper chamber 303B from the outer damper chamber 303A. Consequently, after the needle 200 has completed valve closing, when the movable core 300 continues moving toward the lower side and collides against the first cylindrical member 110, the moving speed of the movable core 300 is decreased. Accordingly, the energy of collision between the movable core 300 and the first cylindrical member 110 is minimized.

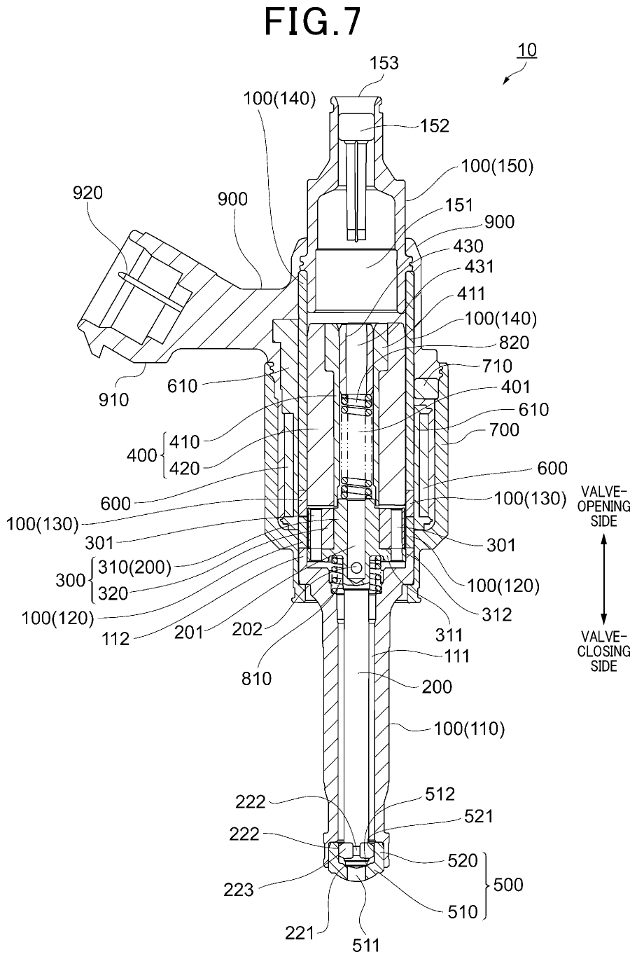

Referring to FIG. 7, a sixth embodiment will be described. The following description mainly explains differences from the first embodiment. Explanation on matters common to the first embodiment will be omitted as appropriate.

In the present embodiment, the movable-side high rigidity portion 310 of the movable core 300 is integrated with an upper side portion of the needle 200. Of the needle 200, the portion to be abutted on the fixed-side low rigidity portion 420 is subjected to nitriding treatment in the present embodiment as well. Of the needle 200, the portion contacting the large diameter portion 112 of the first cylindrical member 110 and sliding thereover (i.e., the outermost surface 312 of the large diameter portion 311) is subjected to nitriding treatment and provided with a DLC coating in the present embodiment as well. In such a configuration as well, advantageous effects similar to those described in the first embodiment can be achieved.

Some embodiments have been described so far referring to specific examples. However, the present disclosure should not be construed as being limited to these specific examples. The those skilled in the art may appropriately modify these specific examples in design, and these modified examples are included in the range of the present disclosure as long as they have characteristics of the present disclosure. The components, the arrangement thereof, conditions, shapes or the like are not limited to those which have been exemplified above but may be modified as appropriate. Combinations of the components of the specific examples described above may be appropriately changed as long as no contradiction arises from the change.

A fuel injection valve according to the present disclosure includes a housing (100) that has an end in a longitudinal direction at which an injection port (511) for injecting fuel is formed; a needle (200) that opens or closes the injection port by moving inside the housing in the longitudinal direction; a fixed core (400) that is a member having at least a part made of a magnetic material and is fixed to the inside of the housing; a movable core (300) that is a member having at least a part made of a magnetic material and is disposed in a state of being movable together with the needle in the longitudinal direction inside the housing; and a coil (600) that generates a magnetic attractive force between the fixed core and the movable core. The fixed core includes a fixed-side high rigidity portion (410) having high rigidity and a fixed-side low rigidity portion (420) having rigidity lower than that of the fixed-side high rigidity portion. The movable core includes a movable-side high rigidity portion (310) having high rigidity and a movable-side low rigidity portion (320) having rigidity lower than that of the movable-side high rigidity portion. The fuel injection valve is configured such that current fed to the coil generates a magnetic attractive force to cause the movable core to move toward the fixed core together with the needle and to cause the movable-side high rigidity portion to abut on the fixed-side high rigidity portion.

In the fuel injection valve having such a configuration, the fixed core includes a part that is a fixed-side high rigidity portion having high rigidity, instead of being entirely formed using a magnetic material having low rigidity. Similarly, the movable core includes a part that is a movable-side high rigidity portion having high rigidity, instead of being entirely formed using a magnetic material having low rigidity.

When current is fed to the coil and the movable core moves toward the fixed core together with the needle to inject fuel, the movable-side high rigidity portion abuts against the fixed-side high rigidity portion. Thus, since portions having relatively high rigidity collide with each other, damage due to collision is minimized in both the fixed core and the movable core.

For example, if the fixed-side low rigidity portion of the fixed core is made of a magnetic material, the fixed-side high rigidity portion does not have to contribute to generating a magnetic attractive force. Therefore, the fixed-side high rigidity portion may be made of a non-magnetic material having relatively high rigidity. Similarly, if the movable-side low rigidity portion of the movable core is made of a magnetic material, the movable-side high rigidity portion does not have to contribute to generating a magnetic attractive force. Therefore, the movable-side high rigidity portion may be made of a non-magnetic material having relatively high rigidity.

According to the present disclosure, a fuel injection valve capable of preventing damage of a fixed core and a movable core can be provided.

What is claimed is:

1. A fuel injection valve comprising:
a housing that has an end in a longitudinal direction at which an injection port for injecting fuel is formed;
a needle that opens or closes the injection port by moving inside the housing in the longitudinal direction;
a fixed core that is a member having at least a part made of a magnetic material and is fixed to the inside of the housing;
a movable core that is a member having at least a part made of a magnetic material and is disposed in a state of being movable together with the needle in the longitudinal direction inside the housing; and
a coil that generates a magnetic attractive force between the fixed core and the movable core, wherein
the fixed core includes a fixed-side high rigidity portion having high rigidity and a fixed-side low rigidity portion having rigidity lower than that of the fixed-side high rigidity portion;
the movable core includes a movable-side high rigidity portion having high rigidity and a movable-side low rigidity portion having rigidity lower than that of the movable-side high rigidity portion; and
when current is fed to the coil, the movable core moves toward the fixed core together with the needle by the generated magnetic attractive force and the movable-side high rigidity portion abuts on the fixed-side high rigidity portion.

2. The fuel injection valve according to claim 1, wherein
the fixed-side high rigidity portion is formed so as to extend from an end portion to the other end portion of the fixed core in the longitudinal direction, and
the movable-side high rigidity portion is formed so as to extend from an end portion to the other end portion of the movable core in the longitudinal direction.

3. The fuel injection valve according to claim 2, wherein
the fixed-side high rigidity portion has a portion facing away from the movable-side high rigidity portion and having an outer diameter that is larger than an outer diameter of a portion of the fixed-side high rigidity portion facing the movable-side high rigidity portion, and
the movable-side high rigidity portion has a portion facing away from the fixed-side high rigidity portion and having an outer diameter that is larger than an outer diameter of a portion of the movable-side high rigidity portion facing the fixed-side high rigidity portion.

4. The fuel injection valve according to claim 3, wherein the fixed-side high rigidity portion is joined to an inner surface of the housing.

5. The fuel injection valve according to claim 3, wherein
the fixed-side high rigidity portion includes at least a part disposed inside the fixed-side low rigidity portion, and
the movable-side high rigidity portion includes at least a part disposed inside the movable-side low rigidity portion.

6. The fuel injection valve according to claim 5, wherein
the movable core includes a movable-side through hole passing through the movable-side high rigidity portion in the longitudinal direction, and
The needle is inserted into the movable-side through hole.

7. The fuel injection valve according to claim 3, wherein the movable-side high rigidity portion is configured to slide over the inner surface of the housing in a state of being in contact therewith.

8. The fuel injection valve according to claim 1 wherein the movable-side high rigidity portion is integrated with the needle.

9. The fuel injection valve according to claim 1, wherein at least one of a first portion and a second portion is subjected to high rigidity imparting treatment to enhance rigidity, the first portion and the second portion being portions that slide over each other in a state of being in contact with each other, with the movement of the movable core and the needle.

10. The fuel injection valve according to claim 1, wherein at least one of a first portion and a second portion is subjected to surface treatment of reducing frictional force, the first portion and the second portion being portions that slide over each other in a state of being in contact with each other, with the movement of the movable core and the needle.
